(19) United States
(12) Patent Application Publication
(10) Pub. No.: US 2011/0298423 A1
(43) Pub. Date: Dec. 8, 2011

(54) UNIVERSAL BATTERY CHARGER

(76) Inventor: Freddy Ejeil, Longueuil (CA)

(21) Appl. No.: 13/054,641

(22) PCT Filed: Jul. 17, 2009
(86) PCT No.: PCT/US09/50963

§ 371 Date: Jan. 18, 2011

Related U.S. Application Data
(60) Provisional application No. 61/081,818, filed on Jul. 18, 2008.

(51) Int. Cl. H02J 7/02; H02J 7/00

(52) U.S. Cl. 320/111; 320/107

(57) ABSTRACT

A universal battery charger comprises a body and a holding member biased towards the body. The holding member comprises two electrodes. The electrodes can move in an arc, and provide electrical current when connected to the terminals of a battery to be recharged.

### CROSS-REFERENCE TO RELATED APPLICATIONS

This application claims priority to U.S. Provisional Patent Application Ser. No. 61/081,818, filed Jul. 18, 2008. This provisional application is fully incorporated by reference herein.

### BACKGROUND

The disclosure relates to an external universal battery charging apparatus which is suitable for charging batteries of different shapes and sizes, particularly when the two battery terminals on the battery can vary in placement.

### BRIEF DESCRIPTION

Disclosed, in various embodiments, are universal battery chargers.

In some embodiments, a universal battery charger comprises: a body; and a holding member biased towards the body, the holding member comprising a primary electrode and a secondary electrode, wherein the primary electrode is a moving electrode can move in an arc, and the two electrodes are adapted to provide electrical current to an associated battery inserted between the body and the holding member.

The moving electrode can be associated with a lever arm, the lever arm providing a surface for moving the electrode in the arc. The arc may be of from about 15° to about 40°.

A power source, such as a two-prong electrical plug, may be provided. A battery in the body may also provide electrical current when no external power source is available.

The charger may further comprise a USB port or an AC or DC socket in the body. The charger may further comprise a light adapted to signal that a current is being passed through the associated battery.

The secondary electrode may also be a moving electrode.

In other embodiments, a universal battery charger comprises: a body; and a holding member biased towards the body, the holding member comprising two electrodes, wherein at least one electrode is a moving electrode with a circumferential range of motion, and both electrodes are located between the body and the holding member.

In still other embodiments, a universal battery charger comprises: a power source; a body; and a holding member biased towards the body, the holding member comprising two terminal members; wherein each terminal member comprises a lever arm, one end of the lever arm defining a center around which the lever arm rotates, and the other end of the lever arm comprising an electrode, the electrode being operatively connected to the power source.

In further embodiments, a universal battery charger comprises: a two-prong electrical plug; a body; and a holding member biased towards the body, the holding member comprising two electrodes, wherein each electrode can move in an arc and is operatively connected to the electrical plug.

In more specific embodiments, a universal battery charger comprises: a two-prong electrical plug; a body; a holding member biased towards the body, the holding member comprising two electrodes, wherein each electrode can move in an arc; a USB port in the body; and an AC or DC socket in the body; wherein the two electrodes, the USB port, and the AC or DC socket are operatively connected to the electrical plug.

These and other non-limiting characteristics of the luminescent solar collectors of the present disclosure are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a top right perspective view of a battery charger of the present disclosure.

FIG. 2 is a top left perspective view of a battery charger of the present disclosure.

FIG. 3 is a bottom left perspective view of a battery charger of the present disclosure showing components between the body and the holding member.

FIG. 4 is a top right perspective view of a battery charger of the present disclosure.

FIG. 5 is right side view of a battery charger of the present disclosure.

FIG. 6 is a top view of a battery charger of the present disclosure.

FIG. 7 is a front view of a battery charger of the present disclosure.

FIG. 8 is an enlarged view of the holding member of FIG. 7.

FIG. 9 is a side exploded view of a battery charger of the present disclosure.

FIG. 10 is a side view of another battery charger of the present disclosure.

FIG. 11 is a top view of another battery charger of the present disclosure.

FIG. 12 is a side view of a power adapter which can be used with the battery charger of the present disclosure.

### DETAILED DESCRIPTION

A more complete understanding of the components, processes and apparatuses disclosed herein can be obtained by reference to the accompanying drawings. These drawings are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

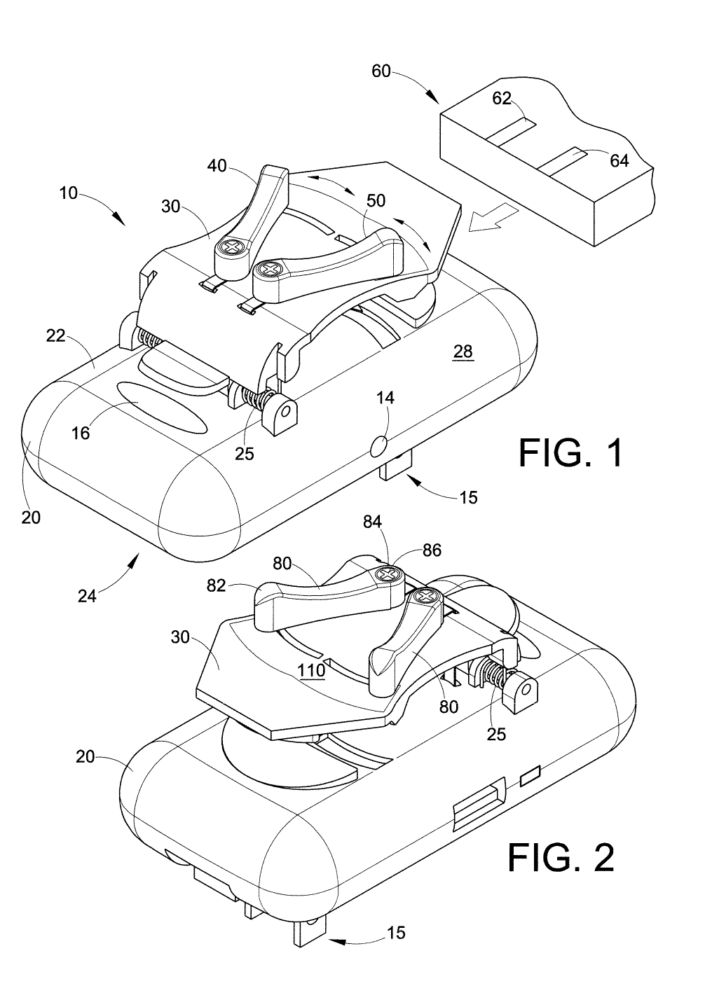

Referring to FIG. 1, the universal battery charger 10 comprises a body 20 and a holding member 30. The body 20 has a generally rectangular shape and contains the necessary circuitry and other equipment of the battery charger. The holding member 30 is located on one side 22 of the body and is biased towards the body, typically with a spring 25.

Located on the holding member 30 are two electrodes, a primary electrode 40 and a secondary electrode 50. These electrodes may also be called contacts or leads. At least one of the electrodes is a moving electrode 70 that can move in an arc. When the positive terminal 62 and negative terminal 64 of a battery 60 are connected, one to each electrode, the two electrodes are adapted to provide electrical current to the battery. The battery 60 is inserted between the body 20 and the holding member 30 and held in place by the clamping action provided by the biasing of the holding member. In particular, portable batteries, for example cell phone batteries, of different sizes can be recharged using the universal battery charger. The distance between positive and negative terminals can differ between cell phone batteries. However, the moving electrode 70 allows the user to change the distance between the two electrodes.

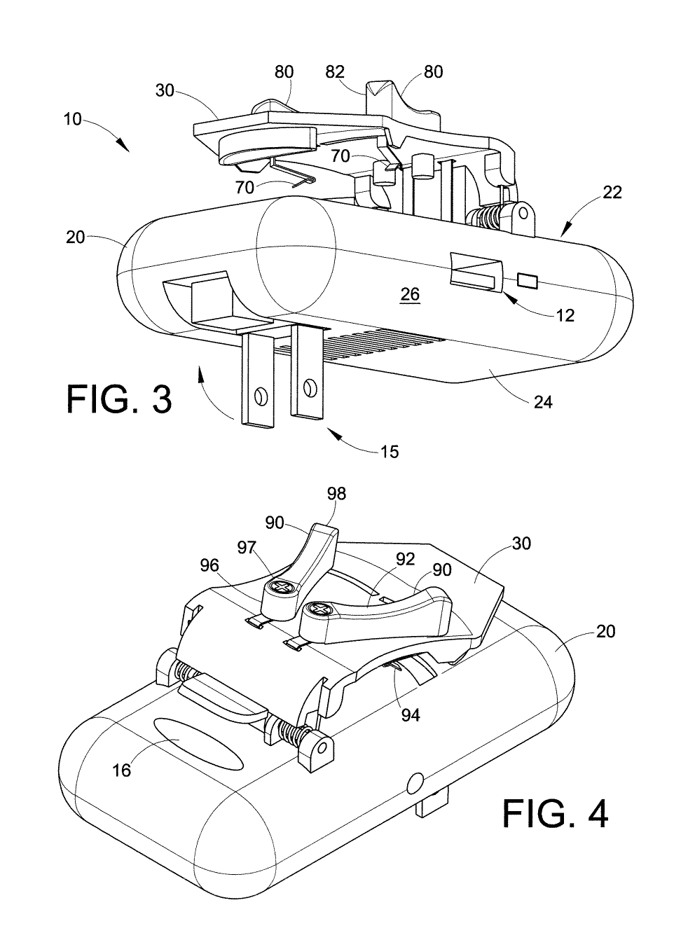

Referring to FIGS. 2 and 3, the moving electrode 70 can be associated with a lever arm 80, the lever arm providing a surface for moving the electrode around the arc. The lever arm is formed from a non-conductive or insulating material, for example plastic. Generally, the electrode 70 is located at one end 82 of the lever arm. The lever arm resembles the hand on a clock. One end 84 is fixed in a central position and the end 82 with the electrode can move in a circle. Thus, the electrode or lever arm can also be considered as having a circumferential range of motion. From another perspective, one end 84 of the electrode or lever arm defines a center 86 around which the electrode or lever arm rotates.

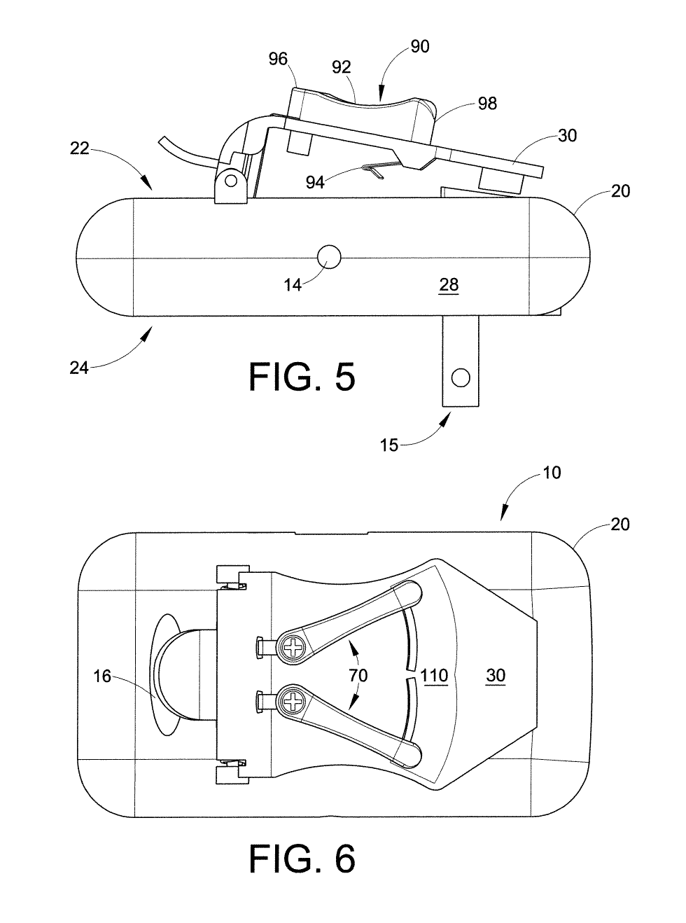

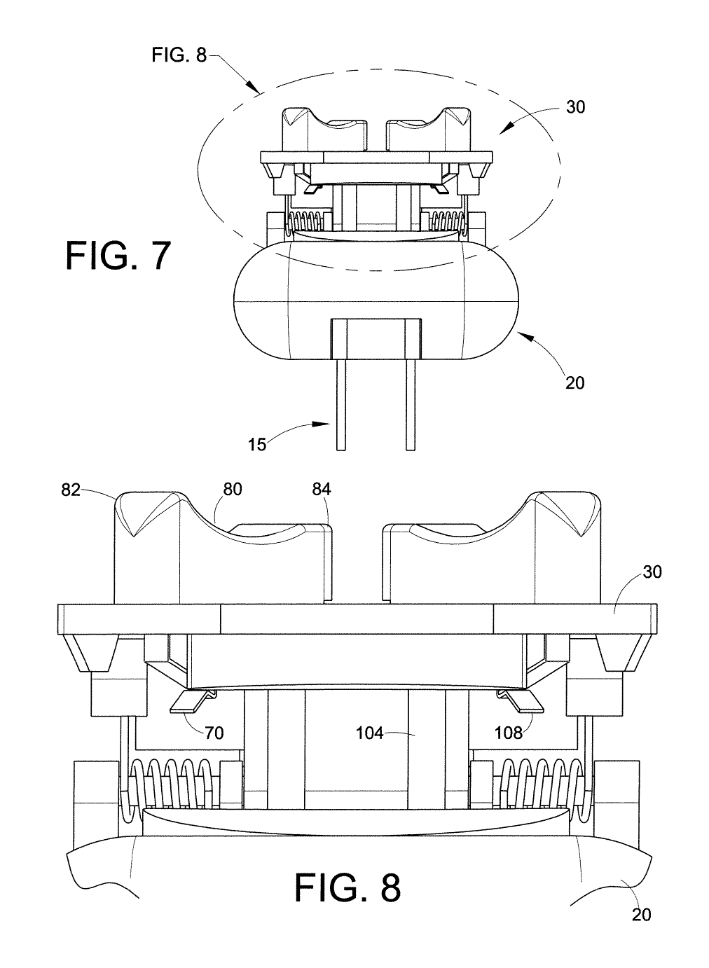

Referring to FIGS. 4 and 5, alternatively, the holding member 30 may be considered as comprising two terminal members 90. Each terminal member 90 comprises a lever arm 92 and an electrode 94. One end 96 of the lever arm defines a center 97 around which the lever arm rotates. The other end 98 of the lever arm comprises the electrode 94.

Again, this capability of moving the electrode allows the electrodes to engage the terminals of a battery independent of the size or shape of the battery. The arc in which the moving member, lever arm, or terminal member can move is from about 15° to about 40°.

The primary and secondary electrodes are operatively connected to a power source 15 which provides electrical current. In embodiments, the power source is a two-prong electrical plug that can be plugged into a standard electrical outlet. The electrical plug may be adapted to move within a 90° arc (see FIGS. 3 and 4) so it can be folded into the body 20 and reduce the overall size of the charger when not being used. The electrical plug 15 is generally placed on a side of the body which is different from the side 22 on which the holding member 30 is located. Typically, the electrical plug is located on the side 24 of the body 20 opposite that of the holding member. The body of the battery charger may also contain a battery (not shown) that can provide electrical current when no external power source is available. The two electrodes, when placed in contact with their respective terminals on the battery, form a circuit that provides electrical current to the battery. Such circuitry is well known in the art.

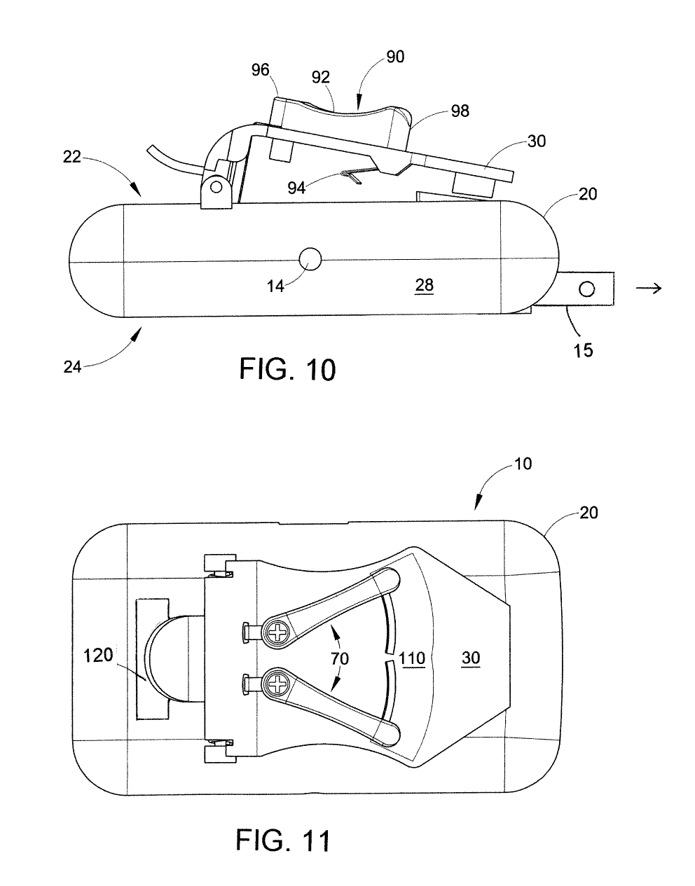

In other embodiments, such as that shown in FIG. 10, the electrical plug 15 slides in and out of one side of the body instead of moving out of the body in an arc. Generally, in such embodiments, the electrical plug is located on a side different from the side 22 on which the holding member is located, such as sides 26, 28, 122, or 124.

The charger may also be adapted to provide electrical current to other electronic devices. In some embodiments, the charger further comprises a USB port 12 in the body. In other embodiments, the charger further comprises an AC or DC socket 14 in the body. The USB port and the socket are also operatively connected to the power source 15 to provide electrical current as well. These connections allow devices, such as an Apple® iPod®, to be recharged as well. Generally, the USB port and the socket are located on sides 26, 28 of the body 20 different from the side 22 on which the holding member 30 is located.

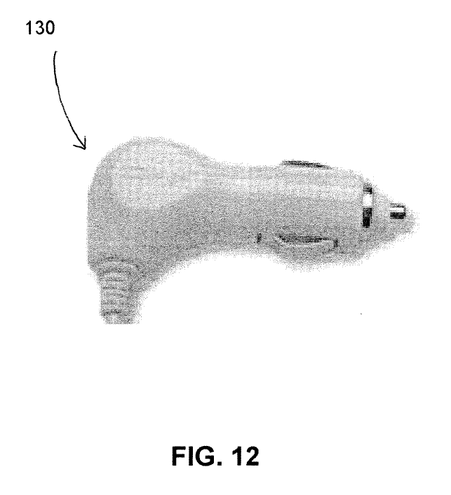

In commercial products, the universal battery charger may also be offered with, for example, a power adapter 130 as shown in FIG. 12. The power adapter may, for example, provide power to the charger through AC or DC socket 14 or USB port 12.

To inform the user that the battery or device is being charged, the charger may further comprise a signal 16, such as a light, that signals that a current is being passed through the battery or device. The light may be, for example, a light emitting diode (LED). Alternatively, in some other embodiments, such as that shown in FIG. 11, the charger may have a display screen 120 for indicating the status of the charger. It is contemplated, for example, that display screen 120 is capable of displaying alphanumeric characters and/or graphic symbols. For example, the display screen could indicate current is passing through the charger or indicate the amount of charge stored in the charger if the charger includes a battery.

In particular embodiments, both the primary electrode 40 and the secondary electrode 50 are moving electrodes 70 that can move in an arc. Similarly, both lever arms or both terminal members can move in an arc as well. This may provide the user with more flexibility in placing the battery relative to the electrodes and any external obstacles (for example, if an electrical outlet is inconveniently located near a large piece of furniture).

As previously mentioned, the battery is inserted between the body and the holding member and held in place by a clamping action. The electrodes may also be considered as being located between the body and the holding member as well.

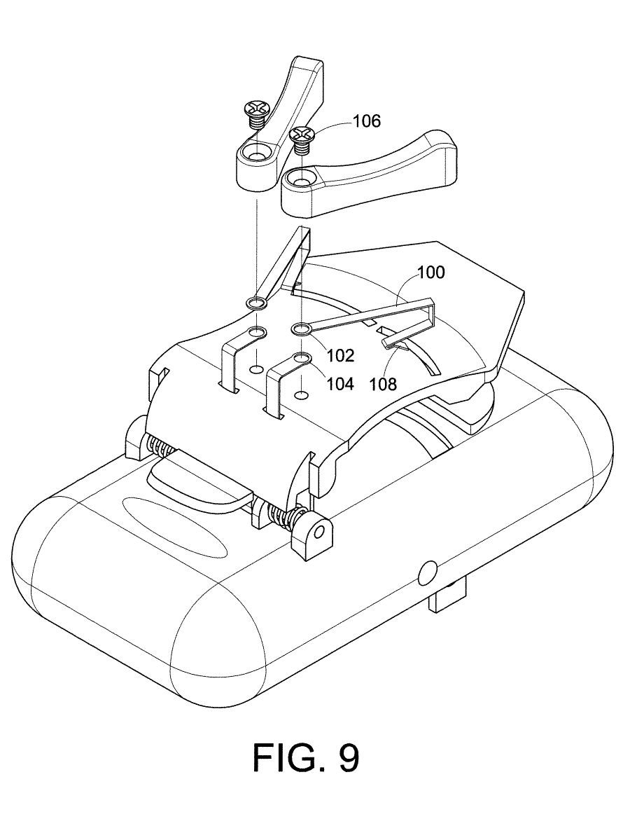

Referring to FIGS. 8 and 9, the electrode 100 is operatively connected, or electrically coupled, to the power source. The electrode is generally made from any conductive material, such as a conductive metal. In particular embodiments, the electrode may be shaped as a generally rectangular piece. A first end 102 of the electrode contains a hole for defining the center around which the electrode rotates. Because the first end is generally fixed in place, the first end 102 usually contacts a conductive member 104 leading from the power source. The conductive member provides the electrical path leading from the body to the holding member and allows for the path to be continuous throughout the range of motion of the holding member. The first end 102 of the electrode and the conductive member 104 can be connected to each other, for example, by providing a hole in the first end and the conductive member, then placing a screw or other fastener 106 through the holes of the electrode first end and the conductive member to fix them together. A second end 108 of the electrode is a resilient contact that resiliently engages the terminal on the battery. This maintains electrical and mechanical contact between the electrode and the terminal.

The holding member 30 may comprise a transparent window 110 or itself be transparent. This aids the user in lining up the electrodes with the terminals of the battery.

In some embodiments, the holding member comprises two moving electrodes and the body comprises a USB port and an AC or DC socket. The electrodes, the USB port, and the AC or DC socket are all electrically coupled to the power source.

The devices of the present disclosure may have an output ranging from about 100 milliampere·hours (mAh) to about 3000 mAh. In some embodiments, the output is limited to below about 500 mAh to reduce the risk of damage to electronic devices being charged.

The devices of the present disclosure have been described with reference to exemplary embodiments. Obviously, modifications and alterations will occur to others upon reading and understanding the preceding detailed description. It is intended that the exemplary embodiments be construed as including all such modifications and alterations insofar as they come within the scope of the appended claims or the equivalents thereof.

1. A universal battery charger, comprising:
a body; and
a holding member biased towards the body, the holding member comprising a primary electrode and a secondary electrode, wherein the primary electrode is a moving electrode that can move in an arc, and the two electrodes are adapted to provide electrical current to an associated battery inserted between the body and the holding member.

2. The charger of claim 1, wherein the moving electrode is associated with a lever arm, the lever arm providing a surface for moving the electrode in the arc.

3. The charger of claim 1, wherein the moving electrode can move in an arc of from about 15° to about 40°.

4. The charger of claim 1, further comprising a power source.

5. The charger of claim 4, wherein the power source is a two-prong electrical plug.

6. The charger of claim 1, further comprising a USB port in the body.

7. The charger of claim 1, further comprising an AC or DC socket in the body.

8. The charger of claim 1, further comprising a light adapted to signal that a current is being passed through the associated battery.

9. The charger of claim 1, further comprising a battery in the body which can provide electrical current when no external power source is available.

10. The charger of claim 1, wherein the secondary electrode is also a moving electrode.

11-20. (canceled)

21. A universal battery charger, comprising:
a power source;
a body; and
a holding member biased towards the body, the holding member comprising two terminal members;
wherein each terminal member comprises a lever arm, one end of the lever arm defining a center around which the lever arm rotates, and the other end of the lever arm comprising an electrode, the electrode being electrically coupled to the power source.

22. The charger of claim 21, wherein each terminal member can move in an arc of from about 15° to about 40°.

23. The charger of claim 21, wherein the power source is a two-prong electrical plug.

24. The charger of claim 21, further comprising a USB port in the body.

25. The charger of claim 21, further comprising an AC or DC socket in the body.

26. The charger of claim 21, further comprising a light adapted to signal a circuit has been formed when the two electrodes are placed at the two terminals of an associated battery.

27. The charger of claim 21, further comprising a battery in the body which can provide electrical current when no external power source is available.

28-33. (canceled)

34. A universal battery charger, comprising:
a two-prong electrical plug;
a body;
a holding member biased towards the body, the holding member comprising two electrodes, wherein each electrode can move in an arc;
a USB port in the body; and
an AC or DC socket in the body;
wherein the two electrodes, the USB port, and the AC or DC socket are electrically coupled to the electrical plug.

35. The charger of claim 1, further comprising a power adapter for providing power to the battery charger.

36-39. (canceled)

40. The charger of claim 5, wherein the two-prong electrical plug moves within a 90 degree arc.

41-47. (canceled)
